(19) United States
(12) Patent Application Publication
(10) Pub. No.: US 2010/0158192 A1
(43) Pub. Date: Jun. 24, 2010

(54) Detection device and process by x-ray imaging with very low dose of objects carried by a moving subject

(75) Inventors: Alain FRIEDERICH, PARIS (FR); Jacques BOURGOIN, THOMERY (FR); GuoCai SUN, BOURG LA REINE (FR)

Correspondence Address: YOUNG & THOMPSON, 209 Madison Street, Suite 500, Alexandria, VA, 22314, US

(73) Assignee: GESEC R & D, THOMERY (FR)

(21) Appl. No.: 12/644,187

(22) Filed: Dec. 22, 2009

(30) Foreign Application Priority Data
Dec. 19, 2008 (FR) 08 58817

(51) Int. Cl. G01N 23/04

(52) U.S. Cl. 378/57

(57) ABSTRACT

A device and a method for X-ray imaging detection of objects on a moving subject, according to a direction of advance, the device includes an X-ray source, a fixed X-ray detector including at least one column formed of m pixels adapted to detect the radiation coming from the interaction of the flux of X-rays with the subject, beam-shaping element adapted to produce a curtain X-ray beam with a width close than that of a column of pixels of the X-ray detector and directed to the column of pixels, two rigid lateral supports adapted to support the X-ray detector, and the beam-shaping element. The X-ray detector is sensitive, has a response time lower than 10 μs, and is adapted to carry out a series of n samplings, each having a time-duration te, during the passage of the subject in front of the column of pixels during the time Tp, generating n column images, the sampling time-duration te being shorter than or equal to the time of transit tp of one point of the subject in front of a column of pixels.

The present invention relates to a device and a method for X-ray imaging detection of objects carried by a moving subject.

The present invention more particularly applies to the security and the control of individuals in restricted areas (for example, airports). More particularly, the invention applies to the detection of objects carried by an individual.

These objects may be, for example, dangerous products (explosives), toxic substances (drugs) and/or weapons.

There exist human walk-through scanners for detecting metallic objects, whose operation is generally based on change of permeability of a loop and does not permit a spatial localisation. Also known are walk-through scanners based on the use of microwave frequency signals, which give only an image of the surface.

Such systems have a very specific use (for example, metal detection) and do not permit the making of images with satisfying resolution.

In the system described below, a flux of X-rays is used, characterised by its energy and dose:

The dose is defined as follow: D=F×Te, wherein F is the flux of X-ray photons and Te is the time of exposure. The irradiation of human cells by a flux of X-rays is liable to introduce irreversible damages.

The legal maximum permissible dose per year for an individual is 1 mSv (milliSievert) (approximately ten times the equivalent of the dose of a pulmonary radiography, which is 0.1 mSv).

Accordingly, the permissible dose for each daily passage of an individual within an X-ray device must be lower than 10⁻³ mSv.

Moreover, there exist X-ray detecting systems, such as that of US 2006/0145080, which allow inspection of contents of vehicles carrying goods.

Other X-ray detection systems are intended to baggage inspection in airports.

Such X-ray detection systems require high doses of X-rays and are can not be applied to the control of individuals.

In such systems, reducing the flux of X-rays for compatibility with the dose objective of 10⁻³ mSv would lead to a degradation of the image quality, which would render the image unexploitable.

Moreover, with the prior-art X-ray imaging systems, the required time of exposure is incompatible with the observation of moving individuals.

Therefore, the object of the present invention is to provide a device and a method for X-ray imaging detection of objects on a moving subject, making it possible to obtain good-resolution images of objects carried by a moving subject, while irradiating the subject with a legally permissible, low dose of X-rays.

To that end, the present invention relates to a device for X-ray imaging detection of objects on a moving subject with respect to said detection device, according to a direction of advance (Y), said device comprising:
a fixed source of X-rays, adapted to emit a flux of X-rays so as to irradiate said subject, the photons generated having an energy comprised between 10 keV and 120 keV,
a fixed X-ray detector comprising at least one column formed of m pixels, adapted to produce simultaneously m electric signals to form a column image, m being higher than or equal to 1, said X-ray detector being adapted to detect the radiation not absorbed by the subject, said subject moving in front of a column of pixels during a time of transit Tp, and one point of said subject moving in from of said column of pixels during a time tp,
means for controlling and synchronizing said X-ray source and said X-ray detector, and
means for digital processing and visualization of said electric signals adapted to reproduce an image of the subject.

According to the present invention:
beam-shaping means are arranged in front of said X-ray source, said beam shaping means being capable of shaping the X-rays emitted by the X-ray source to produce a curtain X-ray beam with a width L close than that of a column of pixels of the X-ray detector and directed to said column of pixels,
said X-ray detector is a sensitive and fast detector having a response time lower than 10 μs, said X-ray detector and the control and synchronization means being adapted to carry out a series of n samplings, each having a time-duration te, during the passage of the subject in front of the column of pixels of said X-ray detector during the time Tp, generating n column images, the sampling time-duration to being shorter than or equal to the time of transit tp of one point of said subject in front of a column of pixels.

Accordingly, the present invention provides a device for X-ray imaging detection of a moving subject, for security purposes, making it possible to obtain very good quality images in a very short time. The irradiation dose received by the subject is very low. In the images obtained, the objects to be detected have a high contrast with respect to the human tissues. The dose received by a subject during each passage within the X-ray imaging detection device is lower than 10⁻³ mSv.

The time of transit Tp of a subject through a security walk-through scanner being of the order of a fraction of a second, the X-ray imaging detection device is capable of making an exploitable image during the time of transit of the subject walking at a normal speed.

The use of a fast and sensitive detector allows the time of exposure Te of the subject to be reduced to a shorter time and thus the irradiation dose to be lowered. This low dose allows an everyday use of the detection device, while using a level of X-ray flux allowing the keeping of the high image quality performance (contrast, resolution) necessary to the identification of objects or products to be detected on the subject.

The present invention also permits the detection of any kind of materials (metal, plastic . . . ).

Such a detection device may thus be used in a detection walk-through scanner in airports. Other applications are also possible, such as inspection of trucks to detect any potential stowaway or illicit goods. The driver can stay in the truck during the control, without risk of receiving a too high irradiation dose.

For the continuous baggage inspection, the present invention permits to avoid damaging the electronic devices or the photosensitive supports, for example. The present invention also permits a faster baggage inspection.

In various possible embodiments, the present invention also relates to the following characteristics, which may be considered either alone or in any technically possible combination and which each provide specific advantages:
the detection device comprises means for automatic triggering and stop of the X-ray source and the X-ray detector, said automatic triggering and stop means being optical triggering and stop means adapted to trigger and stop the X-ray source and the X-ray detector when the subject passes between the lateral supports,
said X-ray source is a continuous-flux source adapted to deliver a continuous flux of X-rays during a time Ti, the time Ti being longer than or equal to the time of transit of said subject in front of a column of pixels,
said X-ray source is a pulsed source adapted to produce a series of X-ray pulses of time-duration ti during the passage of the subject in front of the X-ray detector, the time-duration ti of each X-ray pulse being longer than or equal to the sampling time-duration te.

Such configuration permits the reduction of the overall X-ray dose received by the subject by stopping the irradiation between two intervals of measurement.

The means for automatic triggering and stopping allow the limitation of the total duration of irradiation of the subject in case the latter stops between the source and the X-ray detector. The total duration of irradiation may be delayed for a predetermined period of time.

In an alternative embodiment, a motion detector may cut the X-ray source when the subject is stopped.
the X-ray detector comprises one column of pixels dedicated to the detection of the X-rays not absorbed by the subject, and at least one other column of pixels dedicated to the detection of the X-rays diffused by the subject.

For each sampling, the measure of the direct flux is corrected by the diffuse X-ray background.

The present invention also relates to a method for X-ray imaging detection of objects on a moving subject, according to a direction of advance (Y), said method of detection comprising the steps of:
emitting at least one flux of X-rays so as to irradiate said subject, the photons generated having an energy comprised between 10 keV and 120 keV,
detecting the radiation coming from the interaction of the flux of X-rays with the subject, by means of an X-ray detector comprising at least one column formed of m pixels, producing simultaneously m electric signals associated with a column image, m being higher than or equal to 1,
digitally processing said electric signals and visualizing the reproduced image of the subject. The overall image of the subject is obtained by juxtaposition of the “column” images.

According to the invention:
the X-ray emitted is shaped into a curtain X-ray beam with a width L close than that of a column of pixels of the X-ray detector and directed to said column of pixels,
the response time of the X-ray detector is lower than 10 μs,
one point of said subject moving in front of a column of pixels of the X-ray detector during a time tp, said X-ray detector carries out a series of n samplings, each having a time-duration te, during the passage of the subject in front of the column of pixels of said X-ray detector during the time Tp, generating n column images, the sampling time-duration te being shorter than or equal to the time of transit tp of one point of said subject in front of a column of pixels.

In various possible embodiments, the present invention also relates to the following characteristics, which may be considered either alone or in any technically possible combination and which each provide specific advantages:
the emission of the flux of X-rays and the series of samplings are automatically triggered and synchronized together,
the flux of X-rays is in the form of an X-ray pulse of time-duration ti, n pulses of time-duration ti being emitted during the passage of the subject in front of the X-ray detector, each pulse being synchronized with a sampling to obtain the image of a slice of the subject, the n images obtained being recombined to give back the image of the subject, each sampling having a time-duration te shorter than or equal to the time-duration ti of the X-ray pulse,
n* additional samplings are carried out during each time of transit tp of one point of said subject in front of a column of pixels, generating n×n* column images during the time of transit Tp of said subject in front of the column of pixels, the sampling time-duration te being strictly shorter than the time of transit tp, and n* being higher than 1.

Such configuration allows to increase the image resolution.
during each sampling, a signal associated with a flux of X-rays not absorbed by the subject is measured and a signal associated with a flux of X-rays diffused by the subject is measured, said signals being measured simultaneously and subtracted.

The image resolution can be increased by reducing the pixel-acquisition time during the time of transit of one point of the subject in front of the column of pixels.

The resolution can also be physically increased by reducing the pixel size.

The invention will now be described with reference to the appended drawings, in which:

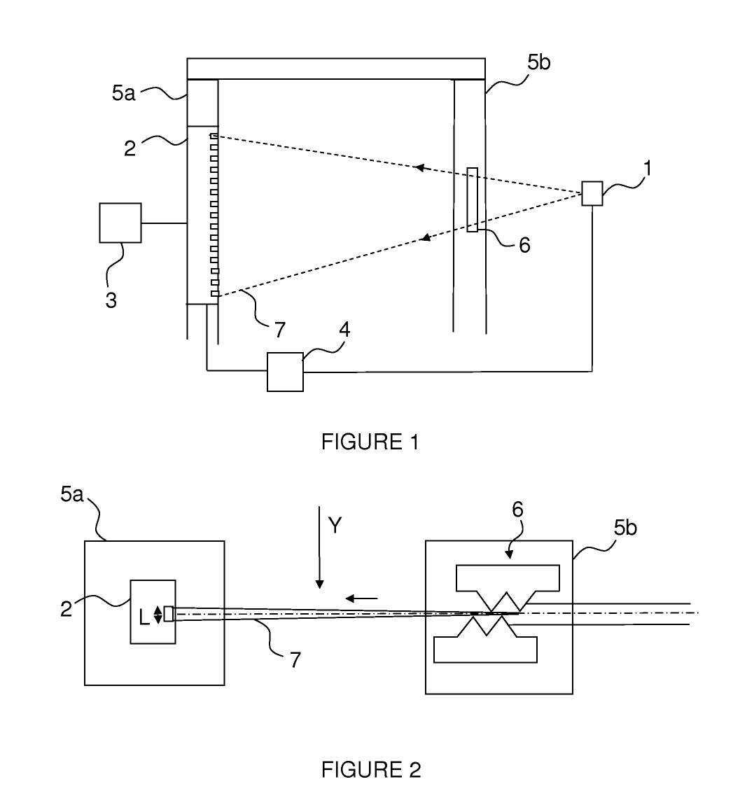

FIG. 1 schematically shows the vertical cross-section of an X-ray imaging detection device according to a first embodiment of the invention;

FIG. 2 schematically shows the horizontal cross-section of this detection device;

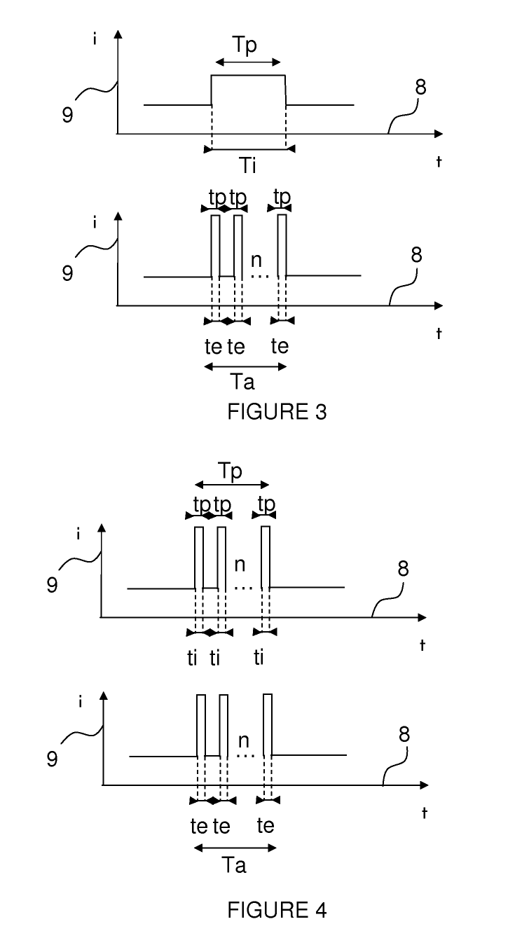

FIG. 3 shows the time-duration ti of a continuous flux of X-rays and the time-duration te of the successive samplings, according to this first embodiment;

FIG. 4 shows the time-duration ti of several X-ray pulses and the time-duration te of the successive samplings, according to this embodiment;

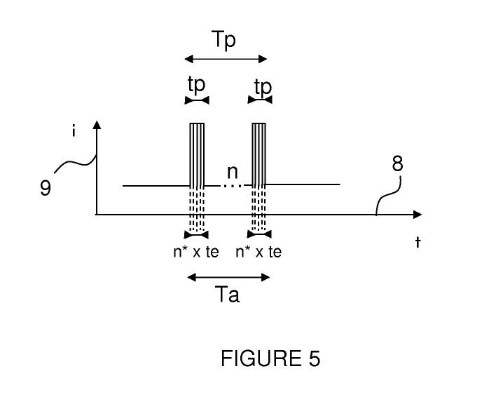

FIG. 5 shows an embodiment of the invention in which the detector accumulates several samplings during the time of transit tp.

FIG. 1 shows an X-ray imaging detection device according to a first embodiment of the invention.

This X-ray imaging detection device is intended to detect objects carried by a subject moving with respect to the detection device according to a direction of advance (Y) of the subject.

As used herein, “subject” means a human or an animal. The subject may be fully or partially inspected.

This detection device comprises two rigid lateral supports 5a, 5b capable of being passed through by the subject. These two lateral supports 5a, 5b can be connected at their upper end by anther part, so as to form a walk-through unit.

This detection device may also comprise also the two lateral supports 5a, 5b.

These two lateral supports 5a, 5b are arranged opposite to each other and are preferentially parallel.

The X-ray imaging detection device comprises a fixed source of X-rays 1 capable of irradiating the subject with a flux of X-rays.

Preferably, the X-rays source 1 illuminates the profile of the subject over the whole height of the latter. It is also possible to irradiate a smaller area of the subject, as for example a slice of the abdomen. It is also possible that the subject passes laterally through the two lateral supports 5a, 5b, in order to obtain a front image of the subject.

This X-ray source 1 generates photons having an energy comprised between 10 keV and 120 keV. This energy is preferentially of about 40 keV. As used herein, the “X-ray source 1” is a single or multiple X-ray source.

The X-ray imaging detection device comprises an X-ray detector 2 comprising at least one column formed of several pixels capable of detecting the radiation coming from the interaction of the flux of X-rays with the subject. This column of pixels generates m electric signals simultaneously, each electric signal being associated with one pixel and m being higher than or equal to 1. These m electric signals form a column image.

Let tp indicate the time of travelling or transit of one point of the subject in front of a column of pixels, according to the direction (Y). The subject passes through the column of pixels and the pixels across the width thereof. The displacement speed of an individual walking normally is about 5 km/h, which corresponds to a time of transit of one point of the subject in front of the column of 1 mm-wide pixels of, for example, 0.7 ms. In other words, one point of the subject covers a distance of 1 mm in 0.7 ms.

The time-duration Tp corresponds to the time of transit of the entire subject in front of a column of pixels (Tp>tp). In other words, the time that passes between the passage of the first point and that of the last point of the subject in front of the column of pixels of the detector 2 is the time Tp.

Beam-shaping means 6 are arranged in front of the X-ray source 1. These beam-shaping means 6, illustrated in FIG. 2, are intended to shape the X-rays emitted by the X-ray source 1 to produce a curtain X-ray beam 7 having a thickness L close to that of a column of pixels of the X-ray detector 2.

Examples of beam-shaping means 6 are disclosed in the document FR 2 622 026. These beam-shaping means 6 can shape an X-ray with a section of precise dimensions. The curtain X-ray beam 7 obtained is thin and orientable in space. These beam-shaping means 6 comprise two shaping pieces shaped as jaws arranged opposite to each other.

FIG. 2 shows an example of beam-shaping means 6, viewed from above.

A first shaping piece has at least two parallel shaping edges defining a first shaping curtain parallel to the direction of the X-ray beam to be shaped.

A second shaping piece has at least one edge parallel to the two edges of the first shaping device, which can fit into these two edges and which is spaced from the curtain defined by these two edges by a distance determining the beam-shaping space. The two shaping devices are moveable relative to each other along a direction perpendicular to the direction of the X-ray beam to be shaped.

The beam-shaping means 6, the X-ray source 1 and the X-ray detector are positioned in such a manner that the curtain X-ray beam 7 is directed to the column of pixels. Preferentially, all the pixels of the column are illuminated.

Advantageously, the thickness L of the curtain X-ray beam 7 (or sheet X-ray beam) substantially corresponds to the width of each pixel of the column of pixels. It may be, for example, 1 mm.

These jaw-type beam-shaping means 6 allow to avoid any stray reflection and limit the problems of diffusion (risk of enlargement of the curtain X-ray beam 7).

Other beam-shaping means 6 may be used, such as those using a narrowing through a cylinder gap.

One or more X-ray sources may be used to illuminate the beam-shaping means 6. Small sources (with low flux of X-rays) may also be distributed along one of the lateral supports 5a, 5b.

The curtain X-ray beam 7 irradiates (or illuminates) a slice of the subject (for example, 1 mm). Each point of the subject passes through the curtain X-ray beam 7. After interaction with the subject and the objects liable to carried by the latter, a curtain X-ray beam, not absorbed by the subject, illuminates the column of pixels.

One of the lateral supports 5b supports the means 6 shaping the X-ray beam 1 and the other lateral support 5a supports the X-ray detector 2.

The distance between the beam-shaping means 6 and the X-ray detector 2 is preferentially of about 1 mm.

The X-ray detector 2 is sensitive (several thousands of electrons per absorbed X-ray photon) and fast with a response time lower than 10 μs. The X-ray detector 2 is adapted to carry out a series of n samplings, each having a time-duration te, during the time of transit Tp of the subject in front of the X-ray detector 2, generating a set of n column images, namely n×m electric signals per column of pixels. Each sampling is associated with a slice of the subject. To each sampling of a slice of the subject correspond m electric signals, n and m being higher than or equal to 1.

Each sampling has a time-duration te shorter than or equal to the time of transit tp.

The complete acquisition time of the X-ray detector 2 is Ta, with Ta>te.

The time of transit Tp of the subject in front of a column of pixels of the X-ray detector 2 corresponds to an average and probable time of transit because the subject is liable to stop, for example, in front of the X-ray detector 2. In order to avoid an excessive irradiation of the subject that might occur in such circumstances, the irradiation is automatically stopped beyond the time Tp.

The X-ray detector 2 is a direct photon-to-electron conversion, semi-conductor detector, such as described in the prior art documents FR 2,820,243 and FR 2,832, 220.

FR 2,832, 220 discloses that such X-ray detector 2 is a solid detector with a semi-conductor material allowing the direct conversion of photons into electrons. In a possible embodiment, it comprises an epitaxial layer of a semi-conductor material thick enough to efficiently absorb the X-ray photons. In a preferred embodiment, the thickness of this layer depends on the energy of the X-ray photons to be absorbed and is comprised between 100 μm and 1 mm.

Advantageously, the X-ray detector 2 is made of a semi-conductor material with a high atomic number and a forbidden band comprised between 1.4 and 1.6 eV. The free electrons in the material have a mobility higher than 1000 cm² v⁻¹ s⁻¹ and a life time of the order of 10 ns to 100 ns. The semi-conductor material is then chosen amongst the following materials: GaAs, InP or CdTe. With these conditions, it is possible to have an elementary detector with a typical thickness of 100 μm and a response time of the order of the microsecond.

The X-ray imaging detection device comprises electric-signals digital processing and visualization means 3 adapted to reproduce an image of the subject. The digital processing and visualization means 3 comprise low-noise amplifiers each associated with one pixel. These amplifiers are followed with an analog-to-digital converter, and with a storage unit for a subsequent image reconstruction.

It also comprises means 4 of controlling and synchronizing the X-ray source 1 and the X-ray detector 2. The control and synchronization means 4 operate to control either the triggering of the X-ray detector 2 to acquire a sequence of n samplings, or the triggering of the X-ray source 1 to obtain a continuous flux of X-rays or X-ray pulses, or the triggering of both the X-ray source 1 and the X-ray detector 2 in order to obtain a series of n X-ray pulses synchronized with a series of n acquisitions.

The X-ray imaging detection device comprises means for automatic triggering and stop of the X-ray source 1 and the X-ray detector 2. The automatic triggering and stop means are optical triggering means (for example, laser or photodiodes) adapted to trigger the X-ray source 1 and the X-ray detector 2 when the subject passes between the lateral supports 5a, 5b.

They are also capable of stopping the acquisition by the X-ray detector and the flux of X-rays. For example, these triggering means can stop the X-ray source 1 when the subject stops in front of the X-ray detector 2, thus avoiding the latter to receive a too high dose of radiation.

According to a possible embodiment of the invention shown in FIG. 1, the X-ray detector 2 comprises only one column of pixels. It is strip-shaped.

In the following example, the column of pixels is 1 mm wide and man-size high (for example, 2 m). The width of the column of pixels corresponds to that of the pixels. It is chosen as a function of the desired resolution. It may be different from 1 mm.

In a possible embodiment, the X-ray source 1 is a continuous flux source adapted to deliver a continuous flux of X-rays during a time Ti longer than or equal to the time of transit Tp of the subject in front of a column of pixels.

The control and synchronization means 4 control the triggering of the X-ray source 1 for obtaining a continuous flux of X-rays and the triggering of the X-ray detector 2 for acquiring a sequence of n samplings during the generation of the continuous X-ray flux.

When the subject passes through the curtain X-ray beam 7, it is irradiated, at a given time, over only the width of the curtain X-ray beam 7. Each section of the subject is irradiated the same way and receives the same dose of irradiation.

The X-ray detector 2 carries out a series of samplings, on slice basis, as the subject passes in front of the column of pixels.

FIG. 3 provides a comparison between the time-duration Ti of the continuous flux of X-rays produced by the X-ray source 1 and the sampling time-durations te of the column of pixels of the X-ray detector 2.

The abscissa axes 8 represent the time, and the ordinate axes 9 represent the intensity of the continuous X-ray flux and that generated by each pixel, respectively.

The m pixels of the column of pixels are synchronous with each other and carry out the sampling simultaneously. The n successive samplings of the column are carried out during the time Ti of the continuous flux of X-rays.

All the pixels of the column of pixels have the same sampling time-duration te. These samplings are repeated n times (in the horizontal dimension).

m electric signals are obtained (in the vertical dimension) each time the column of m pixels carries out a sampling. These m electric signals are associated with a vertical slice of the subject. A matrix of n×m pixels is obtained, with n columns and m lines.

The time-duration te of each sampling is shorter than or equal to the time of transit tp of one point of the subject in front of the column of pixels. Thus, in this example, the time-duration te of each sampling is thus shorter than or equal to 0.7 ms.

The n×m electric signals obtained are recombined together by the digital processing and visualization means 3 to reconstruct the image of the subject. The images successively obtained by the column of pixels are juxtaposed to each other.

For example, for a 1 mm-wide pixel, a 300 mm-wide subject moving at 5 km/h (time of transit tp of 0.7 ms of one point of the subject in front of a pixel), a sampling time-duration te of 0.7 ms (te=tp) leads to a image resolution of 2 mm. The subject passes in front of the X-ray detector 2 during about 300 ms (Tp). The time-duration Ti if the continuous flux of X-rays is about 300 ms (Ti=Tp).

For a 300 mm-wide subject, the X-ray detector 2 carries out 150 samplings, leading to 150 significant column images. In such conditions, the total number of photoelectrons at the detector is 10⁷.

The irradiation of the subject on slice basis lasts 300 ms (time of transit of the entire subject in front of the detector). All the volume of the subject is irradiated within 300 ms, but the dose received by a slice of the subject during the illumination of the column of pixels is 1/300 (with a 300 mm-wide subject), namely 0.7 10⁻⁴ mSv. After the subject has passed in front of the X-ray source 1 (the flux of which corresponds to a dose of 0.1 mSv for a time of exposure of 1 s), the subject thus receives a total dose of 0.7 10⁻⁴ mSv.

By way of example, a tolerable motion (image blur) corresponding to a time of 10% of the time of transit tp, namely about 70 μm. This is equivalent to a loss of resolution of 0.1 mm. This time corresponds to the minimum sampling time-duration te for a column of pixels (opening time of the sampling) and leads to a real resolution of 1.1 mm.

For a pixel size of 100 μm and a sampling time-duration te of 70 μs, the image resolution becomes 200 μm, corresponding to 1500 significant columns. Any intermediate combination is possible.

The important parameter is here the sampling of the X-ray detector 2. If the quantity of X-ray photons received by the pixels during the sampling time-duration is sufficient to make an image, the best resolution is obtained thanks to a short sampling, typically of 1 to 100 μs, preferably of 70 μs.

To increase the “real” resolution, the simplest strategy regarding the sampling consists in reducing the pixel size. The minimum size is to be determined as a function of the available flux X-rays, the opacity of the subject to be analyzed, and the desired signal-to-noise ratio (SNR).

The X-ray detector 2 described above makes it possible to achieve such performance, because it has a stabilized response time far lower than 10 μs, a high sensitivity and an almost absence of remanence, which is lower than 1 μs. The number of photon creations in such conditions is 10⁷ electrons (detector at 1 m from the beam-shaping means), which makes it possible to obtain a dynamics of the image higher than 10³.

According to another possible embodiment of the invention, the X-ray source 1 is a pulse source adapted to produce a series of X-ray pulses. The time-duration ti of each X-ray pulse is equal to or longer than the sampling time-duration te of the column of pixels. Each X-ray pulse is synchronized with the sampling of the X-ray detector 2. The sampling time-duration te is equal to or shorter than the time of transit tp of one point of the subject in front of the column of pixels.

In the example of FIG. 4, the time-duration ti of each X-ray pulse is advantageously substantially equal to the sampling time-duration te of the column of pixels. The X-ray pulse time-durations ti and the sampling times te are synchronized together.

The X-ray pulse time-duration ti may also be longer or shorter than the sampling time-duration te.

The X-ray pulses are obtained through modulation of the flux of X-rays into short pulses, typically shorter than 100 μs (direct modulation of the X source or external chopper).

For a column of pixels of 1 mm and a subject of 300 mm, for example, the total time of transit Tp of the subject in front of the X-ray detector 2 is about 300 ms. The series of X-ray pulses and acquisition operations Ta last about 300 ms. The time-duration ti of each pulse is advantageously shorter than the time of transit tp of one point of the subject in front of the column of pixels, namely shorter than 0.7 ms.

As for the time-duration te of each sampling, it is advantageously equal to the time-duration ti of an X-ray pulse.

The use for X-ray pulses makes it possible to reduce the dose received by the subject by a factor 10, for example, by pulsing the X-ray beam during 70 μs every 0.7 ms. In such conditions, the spatial resolution remains of 1 mm. Accordingly, it is possible to interrupt the flux of X-rays between two measurements and thus to reduce the overall dose receive by the subject.

To recover the signal due to an irradiation of 0.7 ms, it is possible to multiply the flux of X-rays by 10. The subject then receives a dose of 0.7 10⁻⁴ mSv. This opportunity is interesting if the SNR is too low. Nevertheless, a factor 10 is gained in the resolution.

For a 1 mm-wide pixel and a sampling time-duration te of 70 μs (te=ti), the dose received by the subject is of the order of 0.7 10⁻⁴ mSv (total number of photoelectrons of 10⁶ at the detector).

It is also possible to increase the image resolution by reducing the pixel size (example: 100 μm×100 μm). With the above-defined flux of X-rays, a factor 100 is lost in the number of electrons at the X-ray detector 2 (unless increasing the flux of X-rays).

For a pixel size of 100 μm and a sampling time-duration te of 70 μs (te=ti), the image resolution becomes 200 μm, corresponding to 1500 significant columns. In such conditions, the dose received by the subject is of the order of 10⁻⁵ mSv.

Any intermediate combination is possible.

According to another possible embodiment (FIG. 5), to increase the image resolution, it is possible to multiply (or accumulate) the samplings and to obtain, during the time of transit tp of one point of the subject in front of a pixel, which is about 0.7 ms, n* additional column images. n×n* column images are thus obtained during the time of transit Tp of the subject in front of a column of pixels. Therefore, m×n×n* electric signals (m corresponding to the number of pixels in a column) are obtained. The sampling time-duration te is strictly shorter than the time of transit tp, and n* is higher than 1. The time-duration ti of the X-ray pulse may be equal to te or to tp.

The total reconstruction of the image is done by juxtaposition of the signals or column images previously obtained. The number of columns is related to the desired horizontal resolution and is determined by the pixel size and the number of sampling sequences. The resolution (by progressive interpolation) may be multiplied by 10 (case of a sampling during 70 μs).

The summation of these column images comes down to open the detection during 0.7 ms, and results in an improvement of the SNR but also in a resolution that is twice as lower (doubling of the physical pixel size). Any intermediate combination is possible to increase the SNR and to improve the physical resolution up to one millimeter (+0.1 mm).

For example, for a sampling time-duration of 100 μs, the number of columns is multiplied by 7, which increases the resolution by a factor 7.

For example, if tp=700 μs, and taking te=70 μs, the signal is accumulated and acquired 10 times during 70 μs, on a column of 1 mm-wide pixels (pixel of 1 mm×1 mm).

10 column images offset by 0.1 mm are obtained. At this level, a factor 10 is lost in the number of electrons in each image. The summation of these images gives back the image given by one pixel of 1 mm² during 0.7 ms. If the signal is sufficient, this method provides a spatial “resolution” of 0.1 mm.

The subtraction between two successive column images (taken within 70 μs) gives the image Delta related to 70 μs of advance of the subject, which results in the resolution increase by a factor 10.

The image Delta obtained corresponds to one pixel of 0.1 mm. Potentially, this corresponds to a physical resolution of 0.1 mm (if the signal is exploitable).

According to another possible embodiment (not shown), the X-ray detector 2 comprises a column of pixels 10 dedicated to the detection of the X-rays directly transmitted by the subject (or not absorbed), and at least one other column of pixels 11 dedicated to the detection of the X-rays diffused by the subject.

During each sampling, a signal associated with a flux of X-rays transmitted by the subject is measured and a signal associated with a flux of X-rays diffused by the subject is measured. These signals are then subtracted from each other to correct the measure of the direct flux by the diffuse X-ray background.

The digital processing means of the X-ray imaging detection device may comprise means for improving the image contrast. These means make it possible to highlight in an image the objects carried by the subject with respect to the human tissues.

Therefore, the invention provides a system and a method for X-ray imaging detection of objects on a moving subject, for security purposes, making it possible to obtain very good quality images in a very short time. The irradiation dose received by the subject is thus very low (<10⁻³ mSv).

Such a detection device may also be used for baggage inspection in airports and makes it possible to reduce the time necessary for baggage inspection.

1. A device for X-ray imaging detection of objects on a moving subject with respect to said detection device, according to a direction of advance (Y), said device comprising:
a fixed source of X-rays (1), adapted to emit a flux of X-rays so as to irradiate said subject, the photons generated having an energy comprised between 10 keV and 120 keV,
a fixed X-ray detector (2) comprising at least one column formed of m pixels, adapted to produce simultaneously m electric signals to form a column image, m being higher than or equal to 1, said subject moving in front of a column of pixels during a time of transit Tp, and one point of said subject moving in from of said column of pixels during a time tp,
means (4) for controlling and synchronizing said X-ray source (1) and said X-ray detector (2), and
means (3) for digital processing and visualization of said electric signals adapted to reproduce an image of the subject,
characterized in that:
beam-shaping means (6) are arranged in front of said X-ray source (1), said beam shaping means (6) being capable of shaping the X-rays emitted by the X-ray source (1) to produce a curtain X-ray beam (7) with a width L close than that of a column of pixels of the X-ray detector (2) and directed to said column of pixels,
said X-ray detector (2) is a sensitive and fast detector having a response time lower than 10 μs, said X-ray detector (2) and the control and synchronization means (4) being adapted to carry out a series of n samplings, each having a time-duration te, during the passage of the subject in front of the column of pixels of said X-ray detector (2) during the time Tp, generating n column images, the sampling time-duration te being shorter than or equal to the time of transit tp of one point of said subject in front of a column of pixels.

2. A detection device according to claim 1, characterized in that it comprises means for automatic triggering and stop of the X-ray source (1) and the X-ray detector (2), said automatic triggering and stop means being optical triggering and stop means adapted to trigger and stop the X-ray source (1) and the X-ray detector (2) when the subject passes between the lateral supports (5a, 5b).

3. A detection device according to claim 1, characterized in that said X-ray source (1) is a continuous-flux source adapted to deliver a continuous flux of X-rays during a time Ti, the time Ti being longer than or equal to the time of transit Tp of said subject in front of a column of pixels.

4. A detection device according to claim 1, characterized in that said X-ray source (1) is a pulsed source adapted to produce a series of X-ray pulses, each having a time-duration ti, during the passage of the subject in front of the X-ray detector (2), the time-duration ti of each X-ray pulse being longer than or equal to the sampling time-duration te.

5. A detection device according to claim 1, characterized in that the X-ray detector (2) comprises one column of pixels (10) dedicated to the detection of the X-rays not absorbed by the subject, and at least one other column of pixels (11) dedicated to the detection of the X-rays diffused by the subject.

6. A method for X-ray imaging detection of objects on a moving subject, according to a direction of advance (Y), by an X-ray imaging detection device according to claim 1, said method of detection comprising the steps of:
emitting at least one flux of X-rays so as to irradiate said subject, the photons generated having an energy comprised between 10 keV and 120 keV,
detecting the radiation coming from the interaction of the flux of X-rays with the subject, by means of an X-ray detector (2) comprising at least one column formed of m pixels, producing simultaneously m electric signals to form a column image, m being higher than or equal to 1,
digitally processing said electric signals and visualizing the reproduced image of the subject,
characterized in that:
the X-ray emitted is shaped into a curtain X-ray beam (7) with a width L close than that of a column of pixels of the X-ray detector (2), said curtain X-ray beam (7) being directed to said column of pixels,
the response time of the X-ray detector (2) is lower than 10 μs,
one point of said subject moving in front of a column of pixels of the X-ray detector (2) during a time tp, said X-ray detector (2) carries out a series of n samplings, each having a time-duration te, during the passage of the subject in front of the column of pixels of said X-ray detector (2) during the time Tp, generating n column images, the sampling time-duration te being shorter than or equal to the time of transit tp of one point of said subject in front of a column of pixels.

7. A method of X-ray imaging detection according to claim 6, characterized in that the emission of the flux of X-rays and the series of samplings are automatically triggered and synchronized together.

8. A method of X-ray imaging detection according to claim 6, characterized in that the flux of X-rays is in the form of an X-ray pulse of time-duration ti, n pulses of time-duration ti being emitted during the passage of the subject in front of the X-ray detector (2), each pulse being synchronized with the sampling to obtain the image of a slice of the subject, the n images obtained being recombined to give back the image of the subject, each sampling having a time-duration to shorter than or equal to the time-duration ti of the X-ray pulse.

9. A method of X-ray imaging detection according to claim 6, characterized in that n* additional samplings are carried out during each time of transit tp of one point of said subject in front of a column of pixels, generating n×n* column images during the time of transit Tp of said subject in front of the column of pixels, the sampling time-duration te being strictly shorter than the time of transit tp, and n* being higher than 1.

10. A method of X-ray imaging detection according to claim 6, characterized in that, during each sampling, a signal associated with a flux of X-rays not absorbed by the subject is measured and a signal associated with a flux of X-rays diffused by the subject is measured, said signals being measured simultaneously and subtracted.

11. A detection device according to claim 2, characterized in that said X-ray source (1) is a continuous-flux source adapted to deliver a continuous flux of X-rays during a time Ti, the time Ti being longer than or equal to the time of transit Tp of said subject in front of a column of pixels.

12. A detection device according to claim 2, characterized in that said X-ray source (1) is a pulsed source adapted to produce a series of X-ray pulses, each having a time-duration ti, during the passage of the subject in front of the X-ray detector (2), the time-duration ti of each X-ray pulse being longer than or equal to the sampling time-duration te.

13. A method for X-ray imaging detection of objects on a moving subject, according to a direction of advance (Y), by an X-ray imaging detection device according to claim 2, said method of detection comprising the steps of:
emitting at least one flux of X-rays so as to irradiate said subject, the photons generated having an energy comprised between 10 keV and 120 keV,
detecting the radiation coming from the interaction of the flux of X-rays with the subject, by means of an X-ray detector (2) comprising at least one column formed of m pixels, producing simultaneously m electric signals to form a column image, m being higher than or equal to 1,
digitally processing said electric signals and visualizing the reproduced image of the subject,
characterized in that:
the X-ray emitted is shaped into a curtain X-ray beam (7) with a width L close than that of a column of pixels of the X-ray detector (2), said curtain X-ray beam (7) being directed to said column of pixels,
the response time of the X-ray detector (2) is lower than 10 μs,
one point of said subject moving in front of a column of pixels of the X-ray detector (2) during a time tp, said X-ray detector (2) carries out a series of n samplings, each having a time-duration te, during the passage of the subject in front of the column of pixels of said X-ray detector (2) during the time Tp, generating n column images, the sampling time-duration te being shorter than or equal to the time of transit tp of one point of said subject in front of a column of pixels.

14. A method of X-ray imaging detection according to claim 7, characterized in that the flux of X-rays is in the form of an X-ray pulse of time-duration ti, n pulses of time-duration ti being emitted during the passage of the subject in front of the X-ray detector (2), each pulse being synchronized with the sampling to obtain the image of a slice of the subject, the n images obtained being recombined to give back the image of the subject, each sampling having a time-duration te shorter than or equal to the time-duration ti of the X-ray pulse.
